(19) United States
(12) Patent Application Publication
(10) Pub. No.: US 2006/0163270 A1
(43) Pub. Date: Jul. 27, 2006

(54) Single vend vending machine for dispensing periodicals

(76) Inventor: Thomas Lyod Ramey, Dana, NC (US)

Correspondence Address: DORITY & MANNING, P.A., POST OFFICE BOX 1449, GREENVILLE, SC, 29602-1449, US

(21) Appl. No.: 11/046,531

(22) Filed: Jan. 27, 2005

(51) Int. Cl. G07F 11/00

(52) U.S. Cl. 221/89

(57) ABSTRACT

A vending machine for dispensing periodicals one printed periodical at a time is provided. The vending machine includes a housing having a vending side and a back side with the housing forming at least one vending receptacle on the vending side. A money receptacle is provided that is integral to the housing. A plurality of trays is disposed within the housing with the trays slanted to dispense a periodical. A plurality of flaps interacts with the trays to aid in dispensing the periodicals. A drive system is operably connected to the money receptacle. The drive system creates a movement of at least one of the flaps, so that a periodical on one of the trays is dispensable into the vending receptacle upon receipt of a proper amount of money by the money receptacle.

### BACKGROUND OF THE INVENTION

The present subject matter relates to a vending machine for newspapers, magazines, or other periodicals and, more particularly, to vending machines that vend a single newspaper, magazine, or other periodicals at a time.

Newspaper vending machines come in a wide variety of shapes and sizes. The most common newspaper vending machine is one in which a user places coins into a coin receptacle and pulls down on a handle attached to a downward swinging door that is released once the proper coinage is placed in the receptacle. The buyer then removes a single newspaper from a stack of newspapers placed on the inside of the vending machine. Vending machines of this type are simple to manufacture and easy to use. However, the dispensing of the newspaper is left to the trustworthiness and social conscience of the buyer. As the newspaper publishing industry has found to be the case, buyers often pay for one paper at these vending machines, while removing multiple if not all the papers contained within the vending machine for either sale or distribution to others. This loss is passed on to other consumers and advertisers.

To address this issue, different vending machines have been developed in the past that try to dispense a single newspaper, magazine, or periodical at a time. However, these single vend dispensing machines simply do not work to the degree necessary to make them economically viable in the marketplace. These known vending machines have been found to be unduly complex, delicate, unreliable, and generally just too expensive to manufacture.

One major failing of these single vend dispensing machines is that they have trouble taking into account that newspapers, magazines, and other periodicals not only vary in size between different publishers, but also newspapers, magazines, and periodicals of the same title vary in size from edition to edition. For example, a weekday New York Times will have a different thickness than a Sunday edition or even a Saturday edition of the same. Therefore, machines set up to dispense the New York Times during the week may have to be changed during the weekend and vice versa so that the vending machine will only vend a single periodical at a time.

Another problem with single vend vending machines is, that due to their complicated design, often the newspaper, magazine, or other periodical being dispensed will be ripped or damaged by the vending action. This has obvious undesirable consequences.

A different concern with any vending machine used to dispense periodicals is that such machines must be durable enough to withstand the conditions of the environment and of the operation of the machine over an extended period of time. For example, many of these dispensing machines are placed on sidewalks or corners. The machine must be able to handle temperatures in excess of 100° F. while at the same time be able to endure temperatures which also drop below freezing. Also, these vending machines are exposed to elements such as rain, sleet, snow, sunlight, humidity, dust, and wind, which are harsh on the vending machine and its operational components.

A further requirement is that the vending machines must be simple enough to operate not only from a buyer's point of view but also from the point of view of the newspaper worker in charge of loading and maintaining the machine. Therefore, the machine should be able to be easily loaded as well as easy to maintain without requiring constant adjustment on a day-to-day, week-to-week, or even month-to-month basis by the newspaper worker. In this same vein, the vending machine should be easy to operate for the buyer. The buyer should not have to spend time reading complicated instructions on how to dispense the periodical. The purchasing of the periodical should not be a frustrating experience for the buyer.

The vending machine also must be sturdy enough to withstand abuse from not only the newspaper worker who loads the machine, but also from the general public who uses the vending machine daily. A newspaper vending machine is not something that the general public treats in a gentle manner. The vending machine should not have delicate or unduly complex mechanisms that may be easily disturbed or altered by rough treatment or other abuse.

At the same time, the vending machine must also be able to vend a sufficient number of newspapers, magazines, or periodicals to permit the vending machines to be cost effective. Oftentimes, in complicated single vending machines, the number of newspapers or other periodicals that may be distributed by the vending machine is limited due to the amount of complex mechanisms used to vend a single newspaper or periodical at a time. Due to the increase in the number of periodicals that can be distributed, the return on investment for such a machine takes much longer. Further, a newspaper company places a vending machine within a certain geographical area to allow for distribution of a certain number of papers. When the vending machine only holds just a few papers, then the company is required to place more vending machines within that geographical area, thereby cutting down on the feasibility of the use of such vending machines.

A need still exists for vending machines that address such concerns and requirements as outlined above, and which can be produced and used in a cost-effective manner for dispensing newspapers, magazines, and other periodicals.

### SUMMARY OF THE INVENTION

Objects and advantages of the invention will be set forth in part in the following description, or may be obvious from the description, or may be learned through practice of the invention.

The aspects of the present subject matter relate to a vending machine for dispensing printed periodicals one periodical at a time. In an exemplary embodiment, the vending machine possesses a housing having a vending side and a back side, with the housing forming at least one vending receptacle on its vending side. Preferably, a money receptacle is carried within the housing. The buyer of a periodical will place money in the money receptacle to purchase the desired periodical contained within the vending machine.

A plurality of trays is disposed within the housing. The trays are positioned in parallel alignment within the housing and may slant from the back side of the housing toward the vending side of the housing. When filling the vending machine, each tray receives a periodical to be dispensed. The periodicals lay on the tray until such time as the buyer purchases that periodical. Upon purchase of a periodical, the periodical is permitted to slide off the tray into the vending receptacle. To prevent release of the periodical prior to the purchase, a plurality of flaps are provided to close the trays. The flaps interact with the trays in such a manner that the periodicals are prevented from sliding off the trays when the periodicals are placed thereon.

To activate the vending of a periodical, a drive system is provided that is operably connected to the money receptacle. Once the money receptacle receives the proper amount of money from the buyer, the drive system creates a movement of at least one of the flaps so that a periodical on one of the trays is dispensable into the vending receptacle. The buyer can then remove the periodical from the vending receptacle that he/she just purchased without having access to the remaining periodicals contained within their respective trays.

In a preferred embodiment, each of the trays has a respective flap. The flap runs along a portion of the length of the tray to which it corresponds and extends in a vertical direction down to an edge of the tray that is closest to the vending side of the housing. In such a manner, each tray is closed by its corresponding flap, thereby holding the periodical upon the tray until the flap is activated to allow the periodical to slide off the tray. The flaps are preferably rotatable into an open position to release the periodicals from the trays. Preferably, each of these flaps has a length that extends at least a majority of the length of the edges of the trays along the vending side of the housing, while the width of each of the flaps is large enough to hold the periodical on the tray and prevent the periodical from siding over the flap.

To allow the flaps to rotate, each of the flaps preferably includes a shaft fixedly attached to the flap. Advantageously, the shaft may be integral to the corresponding flap along the length of the flap and extends past either end of the flap. Preferably, a cam is carried on one end of the shaft that extends past an end of the flap. In some embodiments, the cams may be operatively connected to just the flaps. In operation, each of the cams rotates the flap connected thereto when that cam is activated.

In some embodiments, cams ride on a rotatable gear belt that is a part of the drive system during operation. In such a drive system, the gear belt defines apertures therein that are properly spaced to allow one of the cams to enter one of the apertures as the gear belt is rotated, whereby the cam rotates the shaft and the flap as the cam enters the aperture. To cause the cam to rotate into the aperture, the cam may have some biasing force applied against it (including gravity). For example, spring loading may create this force. A torsion spring may be placed on the shaft to interact with the cam to spring load the cam.

The drive system may use a drive pulley to turn the gear belt. The drive pulley may be operably connected to a transfer sprocket by a shaft along an axis of rotation of the transfer sprocket and the drive pulley. In this manner, the transfer sprocket and the drive pulley are connected in parallel to each other. This parallel connection allows the transfer sprocket to transfer its rotation directly to the drive pulley that turns the gear belt.

Advantageously, the drive system also includes a drive sprocket that operably engages the transfer sprocket by a chain or some other turning device so that, as the drive sprocket is turned, the chain turns the transfer sprocket and thereby the drive pulley. The gear belt on which the cams ride operatively engage the drive pulley, so that the drive pulley turns the gear belt. The apertures defined within the gear belt are in alignment with cams. The apertures are spaced to allow one of the cams to enter one of the apertures as the gear belt is rotated by the drive pulley, thereby causing the gear belt to activate the cams. This activation causes the flap attached to the activated cam to rotate upward thereby allowing the tray to be opened to dispense one of the periodicals as the gear belt advances.

In some embodiments, it may be advantageous to have the drive system removable from the housing of the vending machine to allow for easier maintenance of and access to the components of the drive system. Having a removable drive system also allows for easy replacement of a malfunctioning drive system.

In one advantageous embodiment, a handle is attached to the drive sprocket to advance the drive sprocket. The handle may have a pawl pivotally attached thereto, while the drive sprocket has a ratchet wheel secured to it with the ratchet wheel and the drive sprocket sharing an axis of rotation. To turn the drive sprocket, the pawl engages the ratchet wheel as the handle is activated. Advantageously, the handle can be operably connected to the money receptacle. When the proper amount of money is received by the money receptacle, the handle can engage the drive sprocket, which turns the transfer sprocket and the drive pulley, causing the gear belt to advance to allow the next flap and tray to be opened to dispense the periodical contained thereon.

In a further embodiment, the drive system employs an activation chain, instead of a gear belt, to interact with the cams attached to the shaft of the flaps. The activation chain has activation levers that are contactable with the cams as the activation chain is rotated by the drive system. The cams extend into the path of the activation levers as the chain is rotated. The levers are properly spaced to allow one of the levers to contact one of the cams, causing the cam to rotate the flap on which the cam is disposed to allow dispensation of a periodical.

To allow stocking and restocking of the vending machine, the housing includes a casing enclosing the vending side of the housing. The casing is opened on its side facing the back side of the housing, and holds the trays on which the periodicals will be placed within this open side. To limit access to the trays, a back cover is used to close the housing. The back cover forms the back side of the housing and can open and close the housing to allow access to the trays for changing and stocking the vending machine. A locking device may be placed on the housing to secure the closure of the back cover to the casing.

In one embodiment, the vending machine includes a base on which the housing stands. The base has a support arm that is attached to the base and supports a support pipe. The support pipe is supportingly attached to the housing. Preferably, the support pipe runs along a corner of the housing where the back cover meets the casing of the housing. In such an embodiment, the back cover is attachably affixed to the support pipe and the casing is rotatable about the support pipe, so that the trays are accessible for loading of the periodicals.

In most embodiments, the housing of the vending machine includes a viewing window on the vending side of the housing so that the buyer is allowed to see the periodical before he/she purchases it. The viewing window may be positioned on the vending side of the housing to permit a periodical placed on a top tray of the trays to be viewed through the viewing window. In such embodiments, the periodical being viewed in the viewing window should be the last one to be dispensed.

In such an embodiment where the top tray displays the periodical in the viewing window, it is advantageous to have a top tray flap that interacts with the top tray to extend the top tray to the viewing window. For example, the top tray flap in its closed position may extend in the same plane as the slanted top tray. In these embodiments, the top tray flap is rotatable downward to release the periodical disposed on the top tray. Other embodiments may exist that allow for display of the periodical in a different fashion, but it is advantageous for the display periodical to be the last periodical dispensed.

Those of ordinary skill in the art will better appreciate the features and aspects of such embodiments, methods, and others, upon review of the remainder of the specification. Other features of the present invention will be described in greater detail below through the use of the appended figures.

### BRIEF DESCRIPTION OF THE DRAWINGS

FIG. 1 shows a perspective front view of an exemplary embodiment of a vending machine according to the present subject matter;

FIG. 2A shows a perspective back view of an exemplary embodiment of a vending machine according to the present subject matter;

FIG. 2B shows a perspective back view of an exemplary embodiment of a vending machine with a back cover removed according to the present subject matter;

FIG. 3A shows a top view along the lines 3A of FIG. 2A of an exemplary embodiment of a vending machine in a closed or locked position according to the present subject matter;

FIG. 3B shows a top view along the lines 3A of FIG. 2A of an exemplary embodiment of a vending machine in an opened position according to the present subject matter;

FIGS. 4A, 4B, 4C, 4D, 4E, and 4F show cross-sectional view along the lines 4 of FIG. 1 of an exemplary embodiment of a vending machine at different stages of vending periodicals according to the present subject matter;

FIG. 5A shows a cross-sectional view of a drive system for an exemplary embodiment of a vending machine in a resting position according to the present subject matter;

FIG. 5B shows a cross-sectional view of a drive system for an exemplary embodiment of a vending machine in a operating position according to the present subject matter;

FIG. 5C shows a cross-sectional view of a top portion of a drive system for an exemplary embodiment of a vending machine during release of a display periodical according to the present subject matter;

FIG. 6 shows a perspective view of a top portion of a drive system for an exemplary embodiment of a vending machine according to the present subject matter;

FIG. 7 shows a perspective view of a gear belt guiding system used in an exemplary embodiment of a vending machine according to the present subject matter;

FIG. 8 shows a gear belt used in an exemplary embodiment of a vending machine according to the present subject matter;

FIG. 9 shows a perspective view of a transfer sprocket and drive pulley used in a drive system of an exemplary embodiment of a vending machine according to the present subject matter;

FIG. 10A shows a schematic view of a release motion for a handle of an exemplary embodiment of a vending machine according to the present subject matter;

FIG. 10B shows a schematic view of another release motion for a handle of a different exemplary embodiment of a vending machine according to the present subject matter;

FIG. 11 shows a perspective view of an activation chain used in a drive system for another exemplary embodiment of a vending machine according to the present subject matter; and

FIG. 12 shows a cross-sectional view of a drive system for a further exemplary embodiment of a vending machine according to the present subject matter.

### DETAILED DESCRIPTION

Reference will now be made in detail to the presently preferred embodiments of the invention, one or more examples of which are shown in the figures. Each example is provided to explain the invention, and not as a limitation of the invention. In fact, features illustrated or described as part of one embodiment can be used with another embodiment to yield still a further embodiment. It is intended that the present invention cover such modifications and variations.

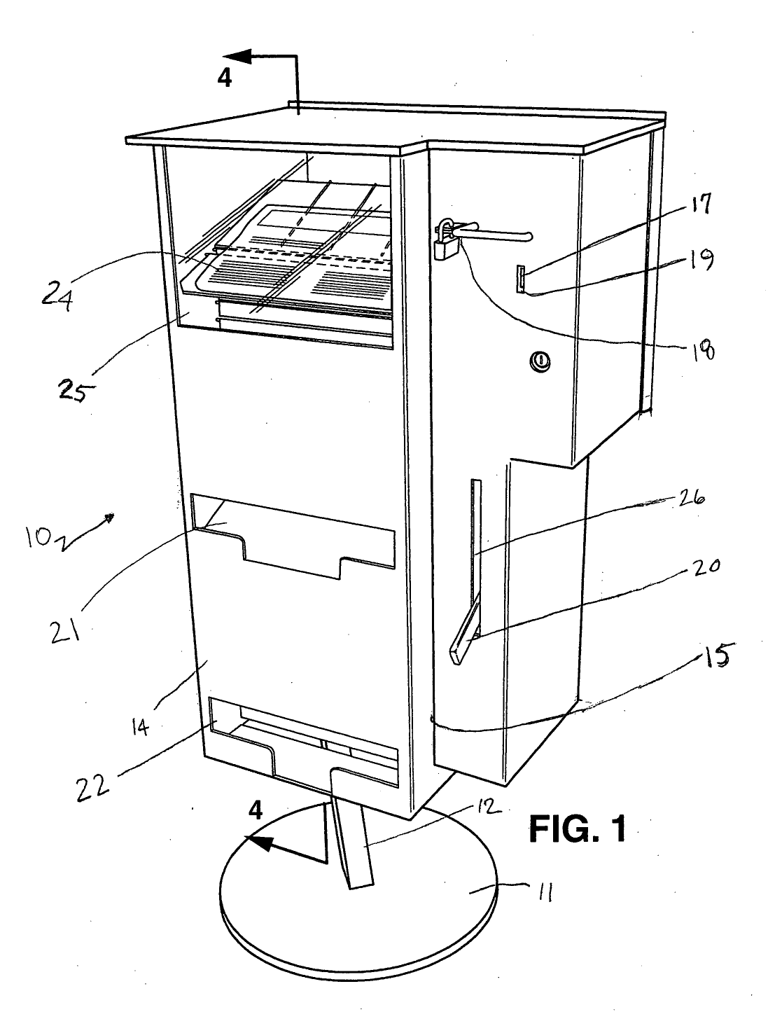

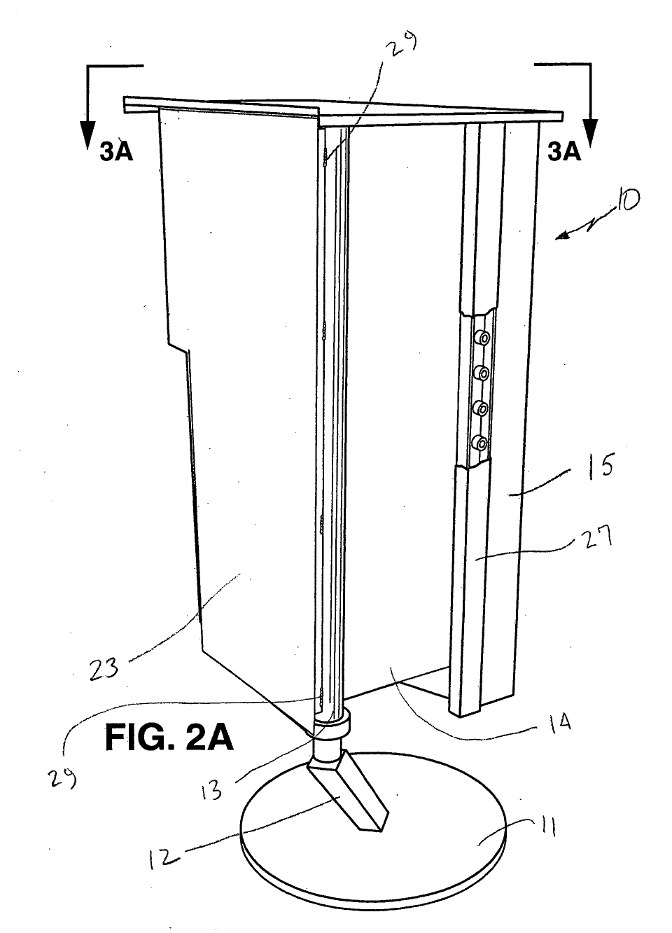

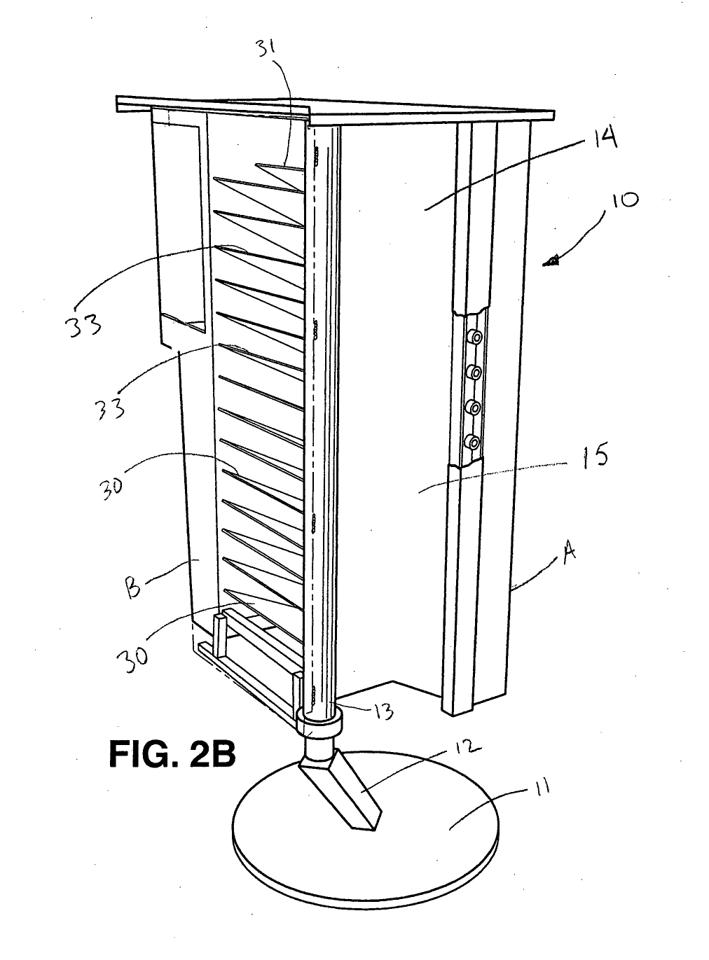

FIG. 1 shows an exemplary embodiment of a vending machine, generally 10, used for dispensing newspapers, magazines, or other periodicals one at a time. The vending machine 10 has a housing 15 that holds a dispensing unit for holding the periodicals and a money receptacle and drive system for operating the dispensing unit to allow one periodical to be dispensed at a time. The housing may be made of two separate parts: a dispensing unit casing 14 and a back cover 23 (as seen in FIG. 2A). The housing containing the dispensing unit and the drive system rests on a supporting arm 12 extending from a base 11. Money is placed into a money slot 17 of a money receptacle 19. This allows activation of a handle 20 that may then be pulled in an upward direction along slot 26, thereby dispensing a periodical 24 into a vending receptacle 21 or 22. In the embodiment shown, two vending receptacles, 21 and 22, are illustrated. However, only one vending receptacle 22, or possibly multiple vending receptacles, may be used.

“Money receptacle” as used herein can be considered to include any mechanism and method used to receive currency, funds, credit, other negotiable or non-negotiable notes, etc. As such, the use of the word “money” is not limited to currency and can represent other types of funds, credit, negotiable or non-negotiable notes, etc. The description of the placing money into a money receptacle can be done in different ways which are conventionally known, such as using a credit or debit card and mechanism or use of a keycard and keycard reading mechanism. Other known methods and mechanisms are contemplated and covered by the meaning of the word “money receptacle.”

The housing 15 has a viewing window 25 for viewing the current edition of the periodical 24 contained within the vending machine 10. Once all the other periodicals contained within the vending machine have been dispensed, the periodical 24 seen through the viewing window 25, may be dispensed to empty the machine. By having the display periodical 24 dispensed last, the vending machine 10 will always display a periodical until the display periodical 24 is dispensed, thereby signifying that the machine is empty.

FIG. 2A illustrates the back of the vending machine 10. The base 11 and the support arm 12 support a vertical pipe 13. In this embodiment, the back cover 23 is fixedly secured to the vertical pipe 13 by attachment members such as welds 29. The welds 29 hold the cover 23 in a stationary position. The casing 14, however, may be rotated along the axis of the vertical pipe 13 to allow access to the inside of the casing 14. Other configurations of the housing may be used to enclose the dispensing unit and drive system. These other configurations do not depart from the scope of the present subject matter.

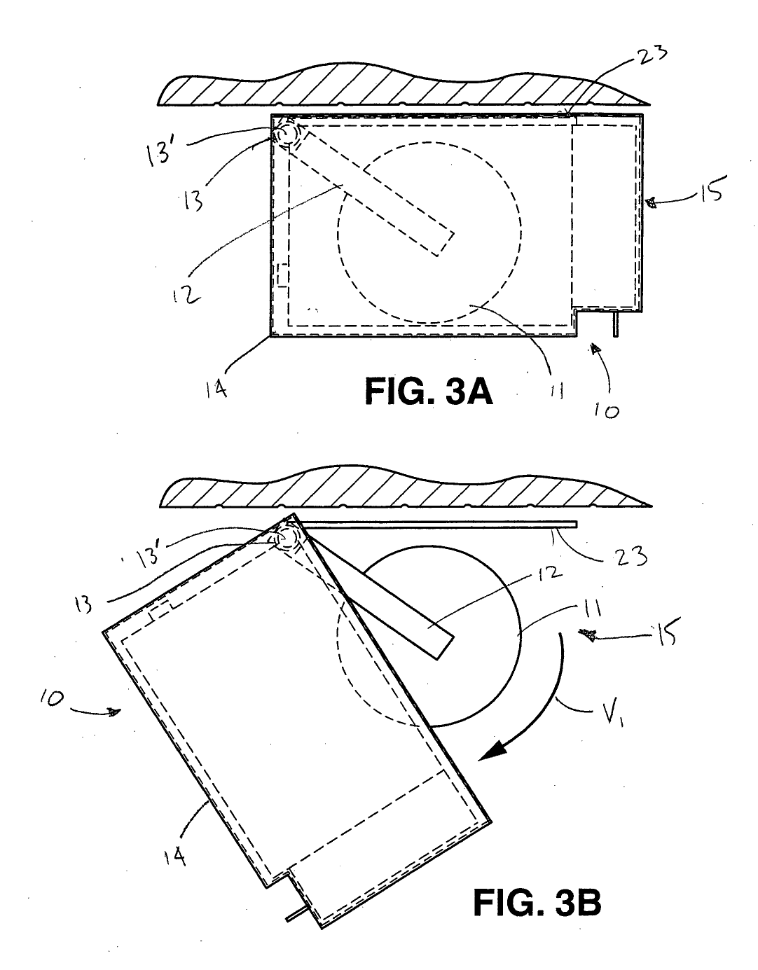

FIG. 3A shows a top view of the vending machine 10 in a closed position with the casing 14 abutting the back cover 23 of the housing 15. When the vending machine 10 is in this closed position, it is preferable to have the vending machine locked to prevent unauthorized access to the interior of the vending machine. A locking device 18, as shown in FIG. 1, may be used to secure the casing 14 of the housing 15 to the back cover 23 of the housing 15. When it is time to change or refill the vending machine 10 with the periodicals, the lock may be unlocked to allow the casing 14 to swing in a direction V₁to allow access to the interior of the vending machine 10, as seen in FIG. 3B. The casing 14 rotates at the vertical pipe 13 on an axis 13′ while the back cover 23 remains stationary.

When the vending machine 10 is opened in this manner, slanted trays 30, 33 including top tray 31 are exposed, as seen in FIG. 2B. FIG. 2B shows a perspective view of the vending machine 10 with back cover cut away. The trays 30, 31, and 33 are held within the casing 14 of the housing 15. These trays 30, 31, and 33 slant from a back side B toward a vending side A of the housing 15. The periodicals to be dispensed may then be placed upon these trays 30, 31, and 33. Once the periodicals are in place, the casing 14 may be pushed against the back cover 23, thereby closing the housing 15. The casing 14 may then be locked in place and the vending machine 10 is again ready to dispense newspapers one at a time.

FIG. 2B illustrates that the casing 14 encloses the vending side A and holds the dispensing unit, including trays 30, 31, and 33, as well as holding the drive system and money receptacle. The casing 14 is opened on backside B of the housing 15 to allow, as stated above, the stocking of the vending machine 10. The back cover 23 of the housing 15, as seen in FIG. 2A, permits the closing of this opening in the casing 14, thereby permitting the closing of the vending machine 10.

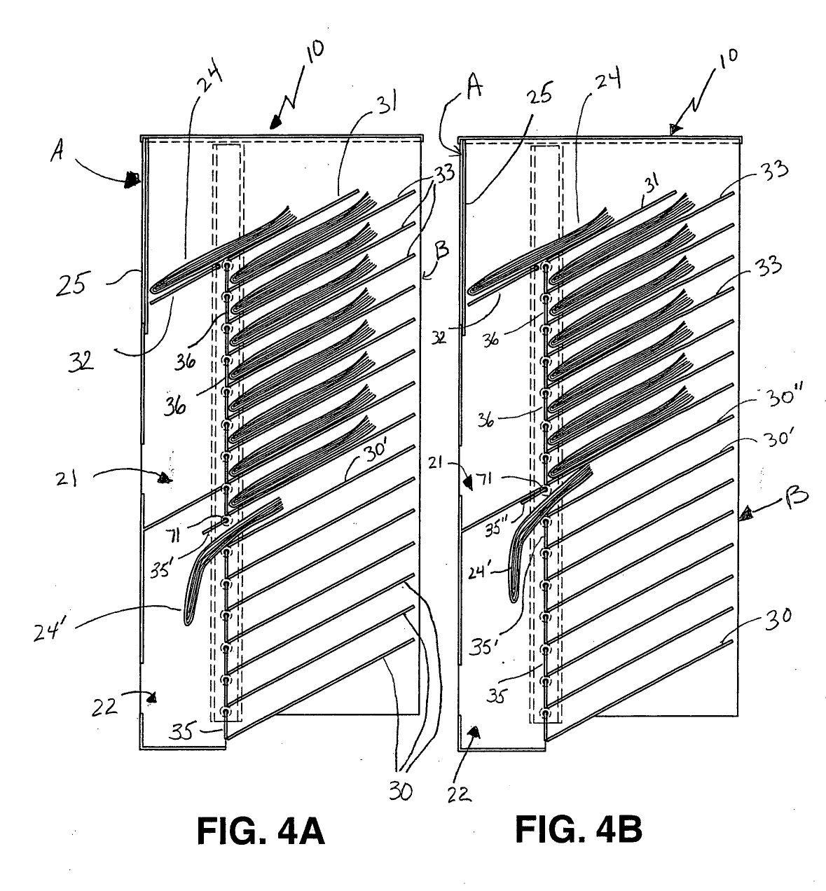

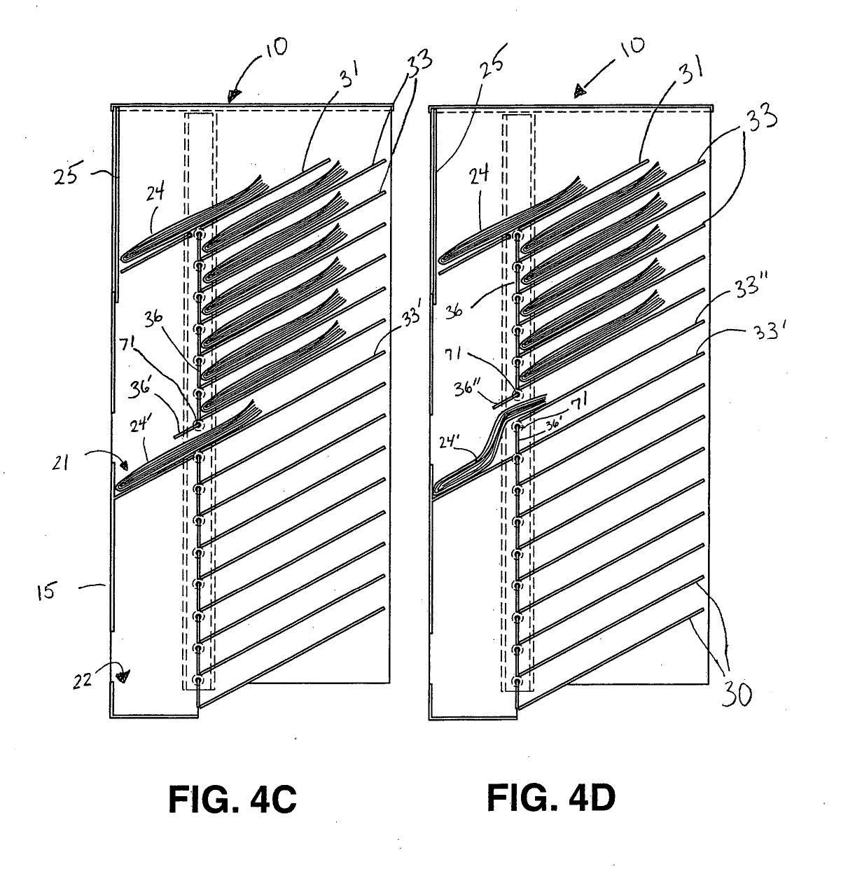

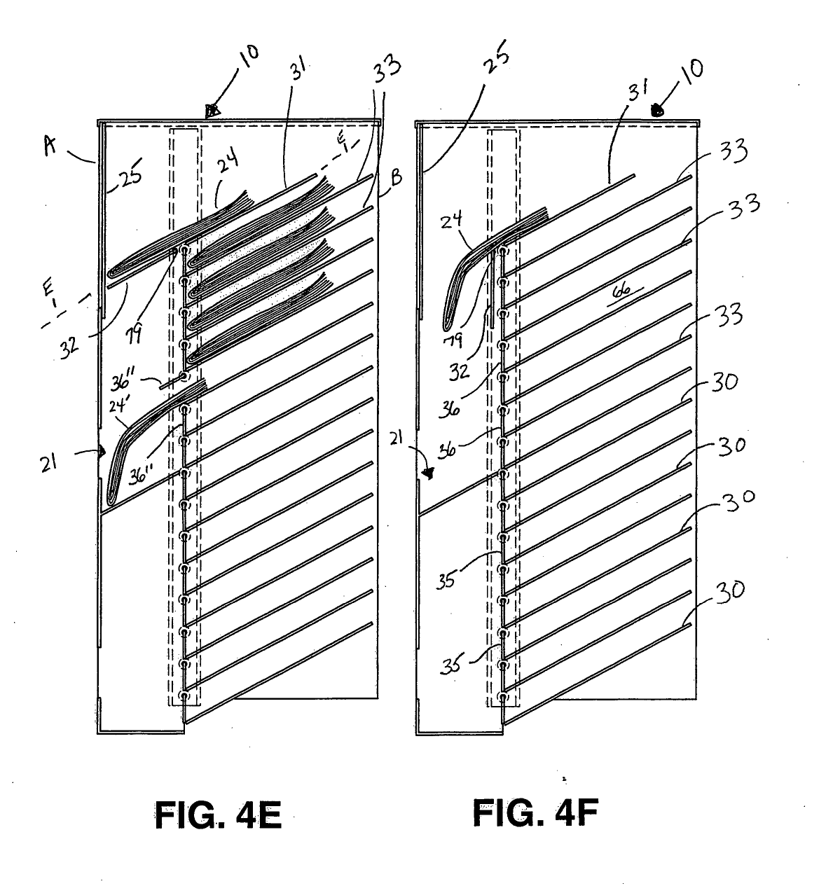

FIGS. 4A-4E show a cutaway side view of the vending machine 10 along the arrows 4 in FIG. 1. In the vending machine illustrated, two vending receptacles 21 and 22 are provided. Lower trays 30 provide periodicals to the lower vending receptacle 22 and upper trays 33 provide periodicals to the upper vending receptacle 21. For each upper tray 33, an upper flap 36 is provided, and, for each lower tray 30, a lower flap 35 is provided. As stated earlier, one vending receptacle may be used in a machine or multiple vending receptacles may be used therein.

FIGS. 4A-4E illustrate how the periodicals are dispensed one at a time. When the periodicals 24 are placed on the trays 30, 33, they slide down the trays 30, 33 until they about against flaps 35, 36. In the case of the top tray 31, the periodical will slide to the front, or vending side A of the vending machine 10, and housing 15, so that the periodical is displaced through the viewing window 25. The slanted positioning of the trays 30 and 33 should be at a great enough angle to cause the periodical placed on each tray to slide forward until it abuts against the flaps 35, 36, which extend vertically down in front of each tray 30, 33. Each tray 30, 33 has a corresponding flap 35, 36 to keep that individual tray 30, 33 in a closed position, thereby keeping the periodical disposed on that tray 30, 33 until such time that its corresponding flap 35, 36 is activated to release the periodical.

For example, FIG. 4A shows the vending machine 10 dispensing a periodical 24′. As can be seen, the first six periodicals that were contained within the vending machine 10 have already been dispensed leaving the lower six trays 30 vacant. When money is placed into the vending machine and the handle 20, as can be seen in FIG. 1, is pulled upward along handle slot 26, the lower flap 35′ is rotated upward by a flap shaft 71. As the lower flap 35′ rotates upward, the periodical 24′ located on the trays 30′ slides off the tray and into the vending receptacle 22. At this point in time, the buyer may retrieve the periodical 24′ from the vending receptacle 22.

As seen in FIG. 4B, when the next buyer places his money into the money receptacle and pulls upward on the handle (see FIG. 1), then the flap shaft 71 rotates the lower flap 35″ upward into an open position, so that the periodical 24′ located on the lower tray 30″ will slide off the lower tray 30″ and into the vending receptacle 22. At this same moment as the handle is pulled upward, the lower flap 35′ closes and once again abuts the lower tray 30′ in a vertical position. Thereby, flap 35′ as well as the other flaps 35 located therebelow are ready for the receipt of a new periodical to be dispensed when the vending machine 10 is refilled.

As can be seen in FIGS. 4C, 4D, and 4E, the paper disposed on the next tray above will be dispensed each successive time that a buyer places the proper amount of money into the money receptacle and pulls upward on the handle 20. As the handle 20 is pulled upward in the slot 26 (see FIG. 1) after the money receptacle receives the proper amount of money, the upper flap 36′ is rotated upward by its shaft 71 allowing the paper 24′ to slide down the upper tray 33′ into the upper vending receptacle 21, which in this case, aligns directly with the tray 33′, to allow the buyer to retrieve the periodical 24′ from the upper vending receptacle 21. The next buyer who places the proper amount of money into the money receptacle will pull the handle 20 upward, thereby opening upper flap 36″, rotating it upward by its shaft 71 and also closing the upper flap 36′ by rotating it downward by its shaft 71. Again, the next buyer will place his money into the money receptacle 19 and pull upward on the handle 20, causing the upper flap 36″ to close and the upper flap 36″′ to open, thereby allowing the periodical 24′ to slide off the tray 33″′ and into the upper vending receptacle 21. Once all the periodicals are dispensed from the upper and lower trays, 30, 33, as seen in FIG. 4F, then the display periodical 24 will be dispensed to the next buyer.

Top tray 31 and top tray flap 32 operate in a different manner than the other trays 30, 33 and flaps 35, 36. In its closed position, top tray flap 32 extends parallel from the end of the tray 31 on the vending side A of the housing 15 toward the housing 15 and viewing window 25 at the vending side A. It is preferable, as shown in FIG. 4E, for the top tray flap 32 to reside generally in the same plane E as the top tray 31 to allow the periodical 24 to slide down to the viewing window 25, thereby allowing passersby to have the best unobstructed view of the periodical 24 contained therein. Unlike the other flaps 35, 36, top tray flap 32 swings downward to release the periodical 24 into the upper vending receptacle 21. To refill the vending machine 10, the handle may be advanced one more position to cause the upper flap 32 to rotate in an upward position to close the top tray 31 and top tray flap 32, making the vending machine ready to be refilled.

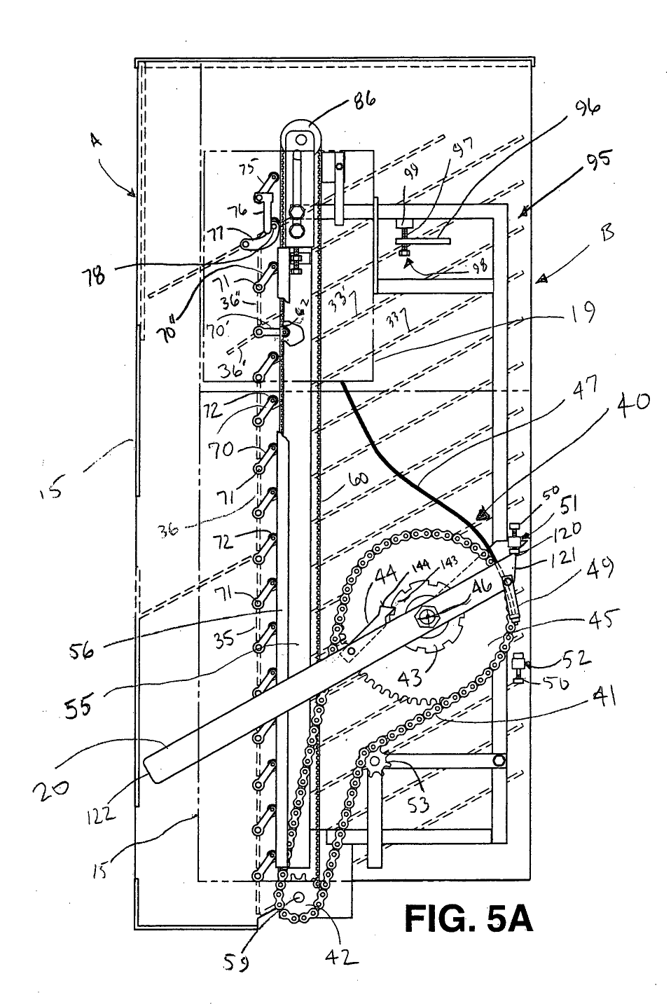

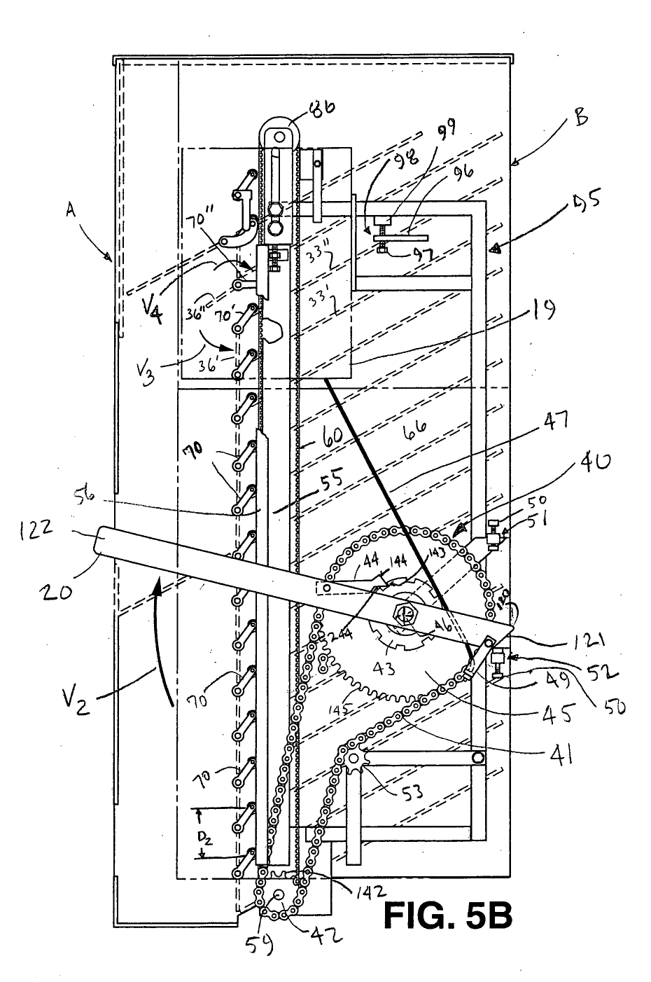

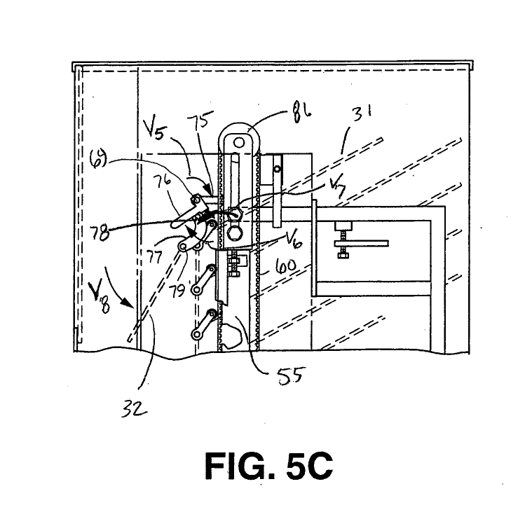

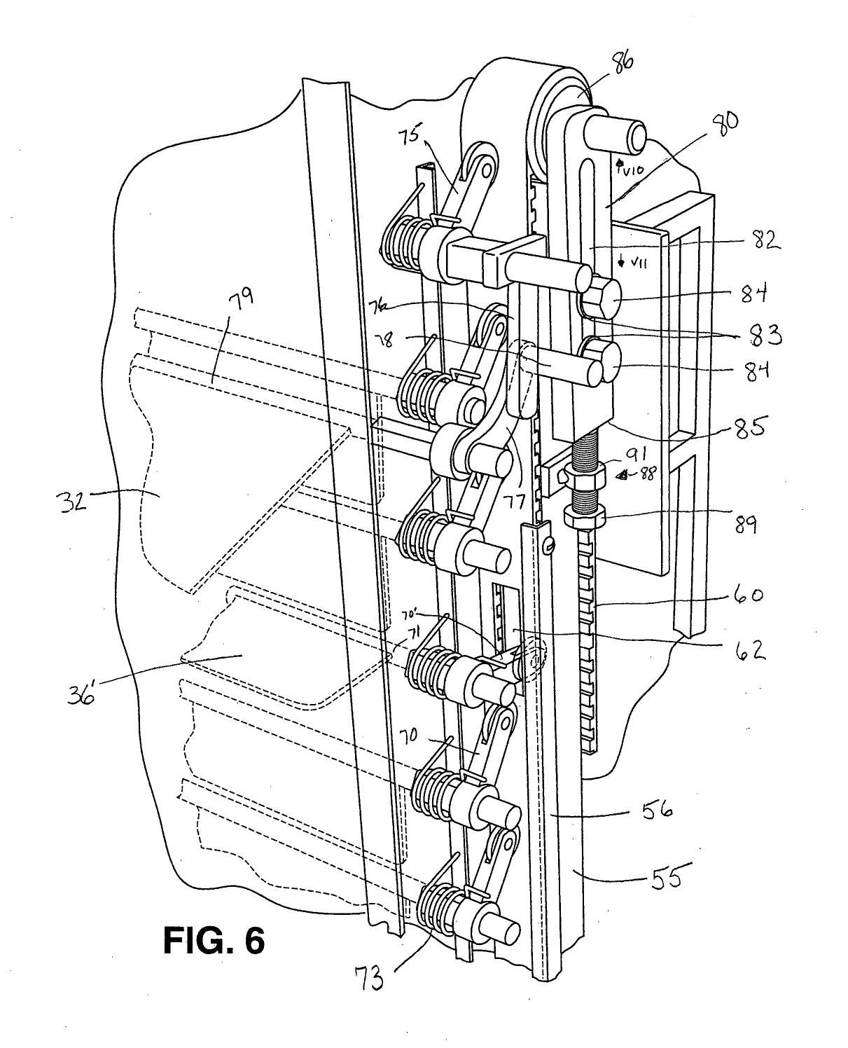

Different mechanical, electromechanical, or computer-controlled drive systems may be used to activate the flaps 35, 36, and 32, causing the flaps 35, 36, and 32 to open and close. These drive systems may be automated or manual as is known in the art. In the embodiment shown in FIGS. 5A, 5B, 5C, and 6, a mechanical drive system is shown that is manually driven. The handle 20 may be lifted in order to advance the gear belt 60 that allows a single flap 35 or 36 to open, while ensuring that all other flaps 35, 36 are closed.

FIG. 5A shows a drive system 40, including a drive sprocket 45, and a transfer sprocket 42 operably engaged with each other through a chain 41. The drive sprocket 45 has a ratchet wheel 43 secured thereto that shares the same axis of rotation 46 as the drive sprocket 45. The handle 20 is positioned beside the ratchet wheel 43. The handle 20 is pivotal around the axis of rotation 46 of the drive sprocket 45 and the ratchet wheel 43. The handle has a back side end 121 and a vending side end 122. In the resting position of the handle 20, the vending end 122 of the handle extends in a downward position outside of the housing 15. Within the housing, a contact surface 120 of the back side end 121 of the handle 20 rests against a resting stop 51. A cable 47 extends from the money receptacle 19 down to a cable bracket 49 attached to the back side end 121 of the handle 20. A pawl 44 is pivotally attached to the handle on the vending side end 122. The pawl 44 has a pushing face 144 that interacts with ratchet wheel teeth 143 disposed on the ratchet wheel 43. In operation, when the handle is pulled upward, the push face 144 of the pawl 44 pushes against the ratchet teeth 143 of the ratchet wheel 43, causing both the ratchet wheel 43 and the drive sprocket 45 to turn about their axis of rotation. This, in turn, drives the transfer sprocket 42.

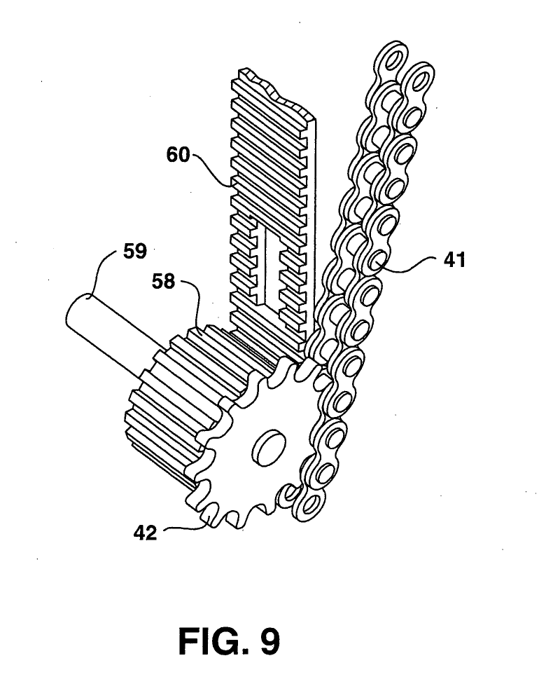

The transfer sprocket 42 is connected to a drive pulley 58 along a shaft 59, as can be seen from FIG. 9. As the transfer sprocket 42 rotates, the shaft 59 also rotates the drive pulley 58. This drive pulley 58, in turn, causes the gear belt 60 to rotate as well, thereby allowing a flap 35, 36 to open (see FIGS. 4A, 4E, and 5A), as will be explained below. The gear belt 60 rotates around and is placed under tension by the drive pulley 58 and the tension pulley 86 (see FIGS. 5A and 5B).

Before money is placed in the money receptacle 19, the money receptacle, in the known manner, holds the cable 47 in a locking position, preventing the handle to be pulled upward. Once the proper specified amount of money has been placed in the money receptacle 19, the cable 47 is unlocked, thereby allowing the handle 20 to be pulled upward at the vending end 122 causing the back side end 121 to be moved from the resting stop 51 to the advancing stop 52, as can be seen in FIG. 5B. In the exemplary embodiment shown in FIG. 5B, the handle 20 is moved in an upward direction V₂, until the back side end 121 of the handle 20 encounters the advancing stop 52. The cable 47, which is under tension, is recoiled or pulled forward due to spring loading or other known mechanism, causing the handle 20 to be pulled back toward the resting stop 51 on the back side end 121 when the user removes the force he/she is applying on the vending end 122 of the handle 20, thereby permitting the handle to resume its resting position and permitting the cable 47 to return to its locked position.

When the cable 47 permits the handle to be moved forward in the direction V₂, the pushing face 144 of the pawl 44 pushes against the ratchet teeth 143 of the ratchet wheel 43, causing the ratchet wheel and the drive sprocket 45, connected thereto, to rotate about their axis of rotation 46. The rotation of the drive sprocket 45 advances the chain 41, which in turn rotates the transfer sprocket 42. The transfer sprocket 42 turns the shaft 59, and the drive pulley 58, thereby, rotates the gear belt 60.

The gear belt 60, as can be seen in FIG. 8, has two equally spaced apertures 62 disposed therein. Due to the clockwise rotation of the handle 20, the drive sprocket 45, transfer sprocket 42, and drive pulley 58 also turn in a clockwise direction. The drive pulley 58, by turning in a clockwise direction, also turns the gear belt 60 in a clockwise direction. The apertures 62 within the gear belt 60 move up the machine on the side of the gear belt 60, which is closest to the vending side A of the machine 10, from the drive pulley 58 toward tension pulley 86. On the side of the gear belt 60 closest to the back side B, the apertures 62 move down the gear belt 60 as it is turned in the clockwise direction from the tension pulley 86 toward the drive pulley 58.

As the gear belt 60 moves upward on the vending side of the gear belt, the gear belt may rest between a channel strut 55 and an angle 56. The channel strut 55 has a channel through the middle, which aligns with the apertures 62 in the gear belt 60. The angle 56 is attached on one side of the channel strut 55, thereby forming a gap between the channel strut 55 and the angle 56 in which the gear belt 60 passes. The channel strut 55 adds support to the belt 60 as it rotates around the pulleys 58, 86, while the angle 56 provides guidance to ensure the belt stays on track. Each flap 35, 36 has a cam 70 attached to the shaft 71 of that flap 35, 36. These cams 70 may have rollers 72 attached. The rollers 72 roll on the gear belt 60 as the gear belt 60 rotates around the drive pulley 58 and the tension pulley 86. In some embodiments, these rollers are not needed or do not rotate as the gear belt rotates. In some embodiments, the cams 70 are under tension forcing-the cams 70 against the gear belt 60. This tension may be caused by mechanisms such as a torsion spring 73 (see FIG. 6) placed on the shaft 71 of the flaps 35, 36.

To explain the operation of the cams 70 with the gear belt 60 uses to open the flaps 35, 36, FIGS. 5A and 5B will be examined more closely. FIG. 5A shows the machine in a resting position with the cam 70′ resting in an aperture 62 of the gear belt 60. Since the cam 70′ is attached to the shaft 71′ of the flap 36′ and the cam has been rotated inward, the shaft 71′ is thereby turned, causing the flap 36′ to be turned upward. With the flap 36′ turned upward, the tray 33′ has been opened to allow the periodical, which had been placed thereon, to be dispensed.

Once the proper amount of money has been placed in the money receptacle 19 and the drive system 40 can be advanced as shown in FIG. 5B, by advancing the handle 20. The advancement of the handle 20 advances the gear belt 60 exactly one position, which is equal to the distance D₂ between one tray to the next (or between one cam to the next). As the gear belt 60 is advanced, the aperture 62 move up one position, causing cam 70″ to fall into the aperture 62 in the direction V₄. At the same time, the movement of the gear belt 60 causes the cam 70′ to be removed from the aperture 62 as the belt moves upward in a clockwise direction. As the cam 70′ is removed from the aperture 62, the cam 70′ is pushed outward to its normal position resting against the gear belt 60, thereby causing the flap 36′ to move in a downward direction, V₃, closing the flap 36′ and the tray 33′. As the cam 70″ enters the apertures 62 of the gear belt 60 in a direction V₄, the cam 70″ turns the flap 36″ upward, causing the flap 36″ to open to allow dispensation of a periodical placed on the tray 33″.

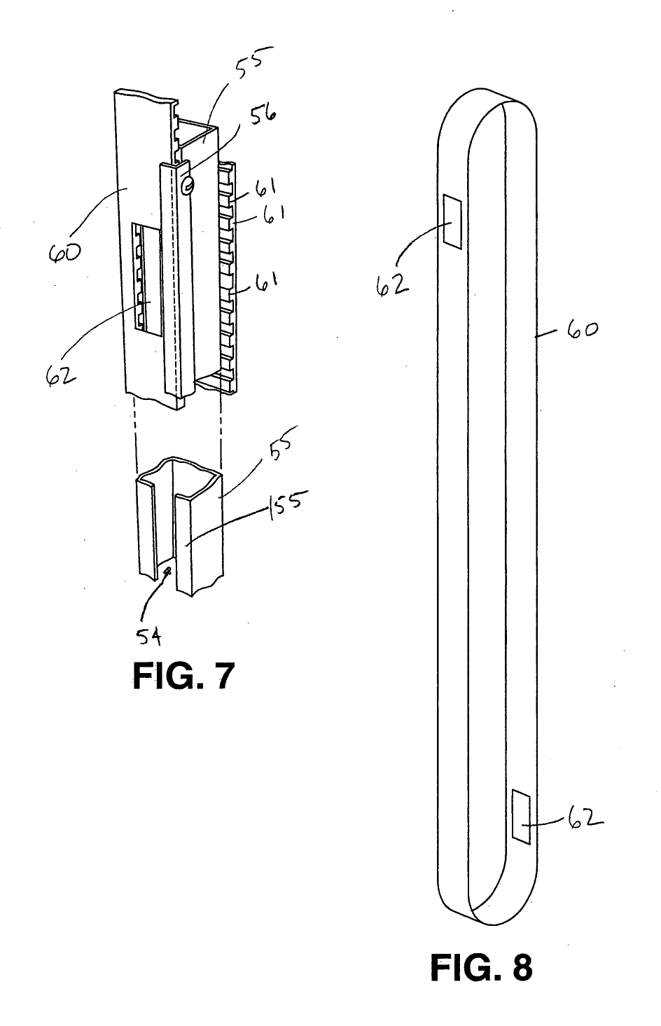

FIGS. 6 and 7 better illustrate the interaction of the cam as well as the gear belt's interaction with the channel strut and angle. As can be seen in FIG. 6, the cam 70′ enters the apertures 62 within the gear belt 60. As the cam 70′ rotates into the apertures 62, the shaft 71 is turned, causing the attached flap 36′ to rotate upward. With the flap 36′ in this upper position, its corresponding tray is now open, allowing the periodical contained thereon to slide off of the tray and into a vending receptacle. In this manner, only one periodical is dispensed at a time.

The channel strut 55, as stated before, adds structure and strength behind the belt 60 and prevents deformation of the belt from the pressure placed thereon by the cams 70. The channel strut 55 forms a channel 54 on the side of the channel strut that interacts with the gear belt 60. As stated above, the apertures 62 within the gear belt 60 align with the channel 54 of the channel strut 55, thereby the sides 155 of the channel strut lend support to the belt while still allowing the cams to extend through the apertures 62 of the gear belt 60. The angle 56 is fixedly attached to the channel strut so that the belt 60 rides between the angle 56 and the channel strut 55. In this manner, the angle 56 provides a loose guide and alignment of the gear belt 60.

To activate the top tray flap 32 in the shown exemplary embodiment, a different cam mechanism assembly is used to provide a downward motion, which opens the tray 31 and the flap 32 as shown in FIGS. 5C and 6. In its closed position, the top tray flap 32 does not extend vertically like the other flaps 35, 36. Instead, top tray flap 32 extends outward from the top tray 31 in a similar slanted position as tray 31 assumes within the vending machine 10, as has been discussed above. To hold the top tray flap 32 in this position, the flap is connected to a shaft 79, which is attached to a curved arm 77. A pin 78 extends perpendicular to the curved arm 77 and parallel to the shaft 79. A top cam 75 rests against the belt 60. This cam 75 is attached to a finger 76 that extends vertically downward so as to extend in front of the pin 78. In this manner, when the cam 75 is resting against the gear belt 60, the finger 76 extends vertically holding the pin 78 and the curved arm 77 in a rear position that keeps the shaft 79 turned upward, thereby holding the top tray flap 32 in its closed position.

As can be seen in FIG. 5C, as the cam 75 enters the aperture 62 of the gear belt 60, the cam 75 moves in a downward direction V₅ about a corresponding rotation of axis created by a connection axle 69. As the cam 75 rotates in the direction V₅, the finger 76, which is rigidly attached to the cam 75 by the axle 69, rotates in an upward and outward direction V₆ also about the axis of rotation corresponding to the axle 69. As the finger 76 rotates in the direction V₆, the pin 78 allows the curved arm 77 to rotate about an axis of rotation corresponding to the shaft 79 in an outward direction V₇. As the curved arm 77 rotates about the axis of rotation corresponding to the shaft 79, the shaft 79 is turned downward, thereby causing the top tray flap 32 to rotate downward in the direction V₈. In this manner, the top tray 31 and the top tray flap 32 are opened to release the periodical displayed thereupon.

In the exemplary embodiment shown in FIGS. 5A and 5B, the flap 32, 35, 36 that prevents the desired periodical from being dispensed from the tray 31, 30, 33 on which it rests is opened by advancing the handle 20 between a resting stop 51 and an advancing stop 52. Once the handle 20 has been advanced to a point where the back side end 121 of the handle 20 resides against the advancing stop 52, then the push face 144 of the pawl 44 stops advancing the ratchet wheel 43. At this point, the handle is allowed to fall back to its resting position as the cable 47 is returned to its locking position. As the handle 20 falls, the pawl 44 slips back over the ratchet teeth 143 through the aid of the indented surface 244 on a bottom side of the pawl 44. Once the handle 20 is at rest again with its back side end 121 resting against the resting stop 51, the pawl 44 again assumes a position to allow the push face 144 of the pawl 44 to push against a respective ratchet tooth 143 to advance the ratchet wheel 43, thereby driving the drive system 40. In this manner, the vending machine 10 is ready for a buyer to purchase the next periodical (if any remain in the machine).

In the shown exemplary embodiment of FIG. 6, the tensioning of the gear belt 60 is adjustable through the positioning of the tension pulley 86. The tension pulley 86 is connected to a gear belt mounting bracket 80. In turn, the mounting bracket 80 is mounted on the channel strut 55 by having mounting bolts 84 extending through a bracket slot 82 defined by the mounting bracket 80 and screwing into the channel strut 55. A tensioning device 88 supports the mounting bracket 80 from a bottom position 85 of the mounting bracket 80. In this embodiment, the tensioning device 88 includes a tension nut bracket 91 attached to the channel strut 55 below where the mounting bolts 84 screw into the channel strut 55 and a tensioning bolt 89 that is screwable through the nut bracket 91. The threaded end of the tension bolt 89 abuts against the bottom position 85 of the gear belt mounting bracket 80.

The mounting bolts 84 are tightened within the slot 82 of the gear belt mounting bracket 80 enough to hold the mounting bracket 80 to the strut 55 in a stable position. Preferably, the mounting bolts 84 are loose enough to slidably engage the slot 82 of the mounting bracket 80 to allow the mounting bracket 80 to slide in an upward vertical direction V₁₀ and a downward vertical direction V₁₁. To increase tension in the gear belt 60, the tensioning bolt 89 is tightened in the nut bracket 91 of the tensioning device 88. This tightening advances the tensioning bolt 89 in the upward direction V₁₀, thereby pushing the mounting bracket 80 upward by the contact of the tensioning bolts 89 with the bottom position 85 of the mounting bracket 80. To release tension in the gear belt 60, the tensioning bolt 89 is loosened in the nut bracket 91, thereby allowing the mounting bracket 80 to descend in the downward direction V₁₁. Through the use of the mounting bracket 80 and the tensioning device 88, the gear belt 60 can be changed easily and also damage to the belt may be prevented by adjusting the tension in the belt.

In a particular embodiment, the drive system 40, including the drive sprocket 45, transfer sprocket 42, handle 20, and gear belt 60, may be placed on a drive system frame 95 that is independently removable from the housing 15. Further, the drive frame 95 and, thus, the drive system 40 may be adjustable to ensure that the gear belt 60 and the cams 70 are properly aligned. One method used to adjust the frame is having a drive frame adjustment device 98. A housing plate 96 is secured to the housing 15 extending horizontally into the area of the drive frame 95. The housing plate 96 may have a threaded hole through which an adjustable bolt 97 may be screwably engaged, contacting a stop 99 on the drive frame 95. By turning the adjustable bolt 97 clockwise or counterclockwise, the drive frame 95 and, thereby, the drive system 40 may be raised or lowered to properly align the gear belt with the cams 70. The housing plate 96 and the adjustable bolt 97 make up a drive frame adjustment device 98. The drive frame adjustment device 98 also includes stop 99. Several adjustment devices 98 may be placed along the housing 15 in the drive frame 95. These adjustment devices may be used to adjust the drive frame 95 and the drive system 40 in either a vertical or a horizontal direction.

To ensure proper operation of the drive system 40 and to allow for easy maintenance of the chain 41, a tensioning device 53 may be used to place tension on the chain 41 when the chain 41 is installed around the drive sprocket 45 and the transfer sprocket 42. This tensioning device 53 may be a tension bar or an idler sprocket that pushes against the chain 41 causing tension in the chain to ensure that the transfer sprocket 42 is properly turned as the drive sprocket 45 is turned. In some embodiments, the tension bar is a spring-loaded bar that pushes against the chain 41 through the force created by a torsion spring against the tension bar.

Another concern for the proper operation of the vending machine 10 in the shown embodiments is to have proper timing within the drive system 40 to ensure that, with each pull of the handle, the gear belt 60 advances one position or the distance D₂ (the distance between one cam to the next) as seen in FIG. 5B. For this reason, the gear ratio between the drive sprocket 45, transfer sprocket 42, and the drive pulley 58, is important. The gear ratio must be set to advance the gear belt 60 one full position and not a fraction thereof. Otherwise, with each advancement of the gear belt 60, the next cam is not guaranteed to fall into the advancing aperture 62. Therefore, the next periodical that is supposed to be dispensed cannot be guaranteed to be dispensed. For this reason, the vending machine needs proper timing to be reliable.

Additionally, the spacing of the trays and cams (or the distance D₂), which defines the distance of one position, is important to ensuring that proper operation of the drive system and the vending machine exists in such embodiments. The spacing of the trays and cams should be generally equal to ensure that each position is equal in size. This uniformity in position size, i.e., uniformity in the distance D₂, defines a set distance that the gear belt 60 must advance to move the properly spaced apertures 62 one position. For this reason, the uniformity in position size aids in proper operation of the vending machine 10 when the spacing of the apertures 62 and the timing of the drive system 40 is proper.

Instead of changing the gear ratio between the drive sprocket 45, transfer sprocket 42, and the drive pulley 58 to adjust or change the distance the gear belt 60 advances, the distance the gear belt 60 advances may also be controlled by the amount of rotation (as measured as an angle) the handle 20 is allowed to travel during the vending of a periodical. The distance that the handle 20 rotates depends on the gear ratio between the drive sprocket 45, transfer sprocket 42, and-the drive pulley 58 as well as the distance D₂ of the spacing of the trays and the configurations of the gear belt or chains used. The angle of rotation of the handle 20 can be translated into an arc length the drive sprocket 45 is turned which further can be used to determine the distance the gear belt advances. The angle of rotation of the handle 20 can be controlled by the stops 51 and 52.

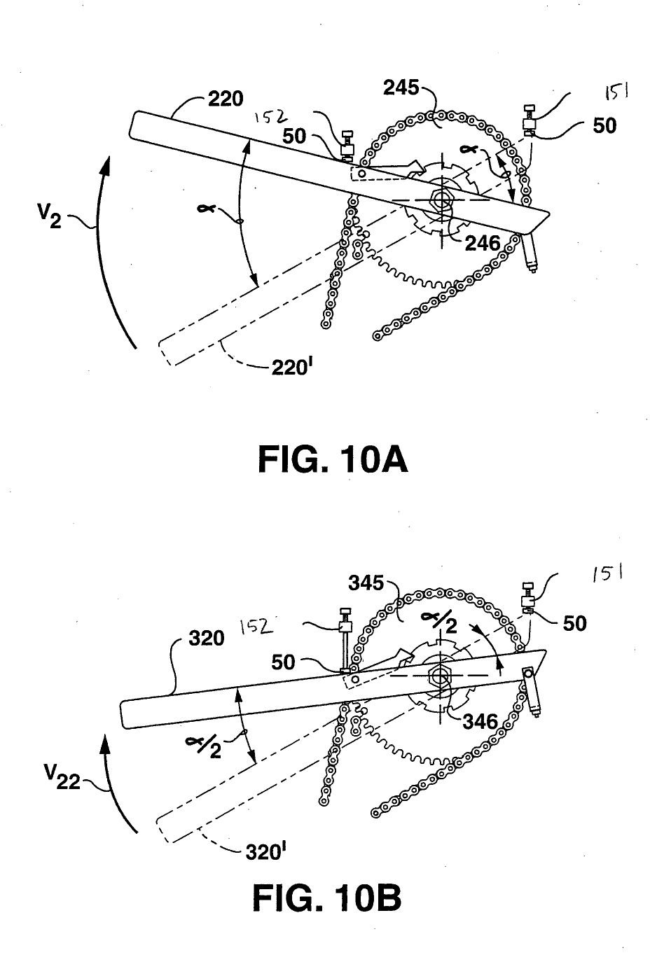

To illustrate, FIGS. 10A and 10B show the angle of rotation of handles for vending machines having a same specified gear ratio and belt configuration but different numbers of trays and flaps. For instance, as seen in FIG. 10A, a handle rotation is shown for a vending machine (not shown), having a specified gear ratio and belt configuration that has 15 equally spaced trays along a latitudinal distance. To dispense periodicals, a handle 220 is pulled up in a rotational motion V₂, which is equal to an arc angle α as measured from a resting position 220′ to the vending position of the handle 220 with an axis of rotation 246 of the handle 220 and a drive sprocket 245.

Conversely, as seen in FIG. 10B, for a vending machine (not shown) having 30 equally spaced trays within the same specified latitudinal distance with the same gear ratio and gear belt configuration as for the vending machine using the handle 220 in FIG. 10A, a handle 320 will only need to be pulled up in a rotational motion V₂₂ that is equal to an arc angle α/2 to dispense the periodicals contained therein. The arc angle α/2 is measured from a resting position 320′ to the vending position of the handle 320 with an axis of rotation 346 of handle 320 and a drive sprocket 345. The arc angle α/2 in FIG. 10B is equal to one-half the arc angle α in FIG. 10A, because the distance the gear belt 60 advances with each pull of the handle 320 for the machine having 30 trays is half of the distance of the machine which contains 15 trays.

As seen in FIGS. 5A, 5B, 10A, and 10B, for fine adjustments of the angle of rotation of the handle, the resting stops 51, 151 and advancing stops 52, 152 have adjustment devices 50 that allow shortening or lengthening of the rotational distance of the handle 20, 220, 320. These adjustment devices 50 may be screws that are then tightened or loosened to decrease or increase the angle of rotation of the handle which affects the degree of rotation of the drive sprocket 45, the transfer sprocket 42, the drive pulley 58, and, in turn, the gear belt 60. It should be understood by those skilled in the art that theses stops 51, 52, 151, 152 may be of different configurations and placements to achieve similar outcomes.

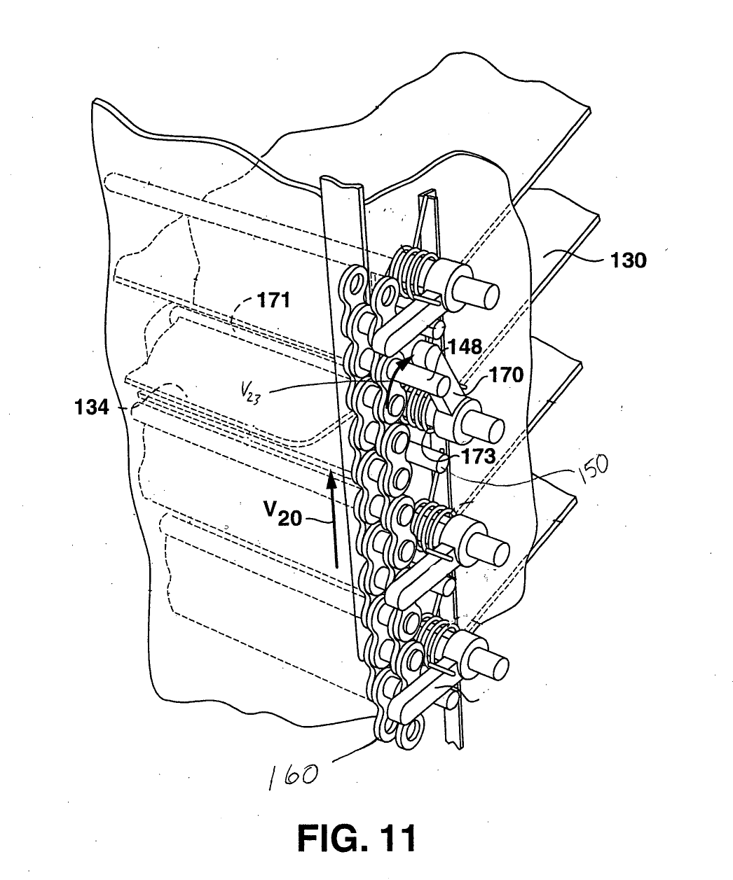

In a further embodiment, an activation chain instead of a gear belt is used to activate the cams and thus open the flaps and trays to dispense a periodical. FIG. 11 illustrates a portion of an activation chain 160 of a drive system for a vending machine for dispensation of a single periodical at a time. The drive system for this vending machine is similar to the drive systems described above. However, instead of a gear belt used to activate the cams, the activation chain 160 is used. The vending machine has a plurality of trays 130 and flaps 134 as described above for dispensing periodicals. The flaps 134 each have a shaft 171 with a cam 170 disposed thereto. Instead of riding on a gear belt as the cams described above, the cams 170 rest on stops 150 and extend outwardly, perpendicular to the path of the activation chain 160, when the flaps 134 are in a closed position.

The activation chain 160 has activation levers 148 which are used to activate the cams as the activation chain 160 rotates in a clockwise direction. As the activation chain 160 is advanced in the direction V₂₀, the lever 148 contacts the cam 170, causing the cam 170 to rotate upward along an axis of rotation corresponding to the shaft 171. The cam 170 in turn rotates the shaft 171 and the flap 134 upward in the direction V₂₃ to allow a periodical residing on the tray 130 to slide off into a vending receptacle (not shown) in a similar manner as described above.

As the activation chain 160 is advanced again, the chain 160 and lever 148 move in the direction V₂₀ to activate another cam, thereby releasing the cam 170 to permit the flap 134 to be closed. To cause the cam and the flap 134 to rotate into a closed position after the lever 148 has moved to the next cam, the cam 170 may have some force applied against it (including gravity). In some embodiments, spring loading may create this force. For example, a torsion spring 173 may be placed on the shaft 171 to interact with the cam 170 to spring load the cam 170.

In some embodiments, an unloading mechanism can be employed to remove the remaining old periodicals left in the vending machine before reloading the vending machine with the next installment of new periodicals. For example, a member of the drive system, i.e., the tension pulley 86 or a chain sprocket, may have an advancing mechanism attached thereto to permit the gear belt 60 or activation chain 160 to be advanced without interaction with the money receptacle 19. This advancing mechanism can be a hand wheel, hand crank, or some other mechanism, or system of mechanisms, known in the art to permit the advancement of the gear belt or activation chain without the insertion of money into the money receptacle. Such an advancing mechanism allows a worker in charge of reloading the vending machine to unload old periodicals from the machine without placing money in the money receptacle.

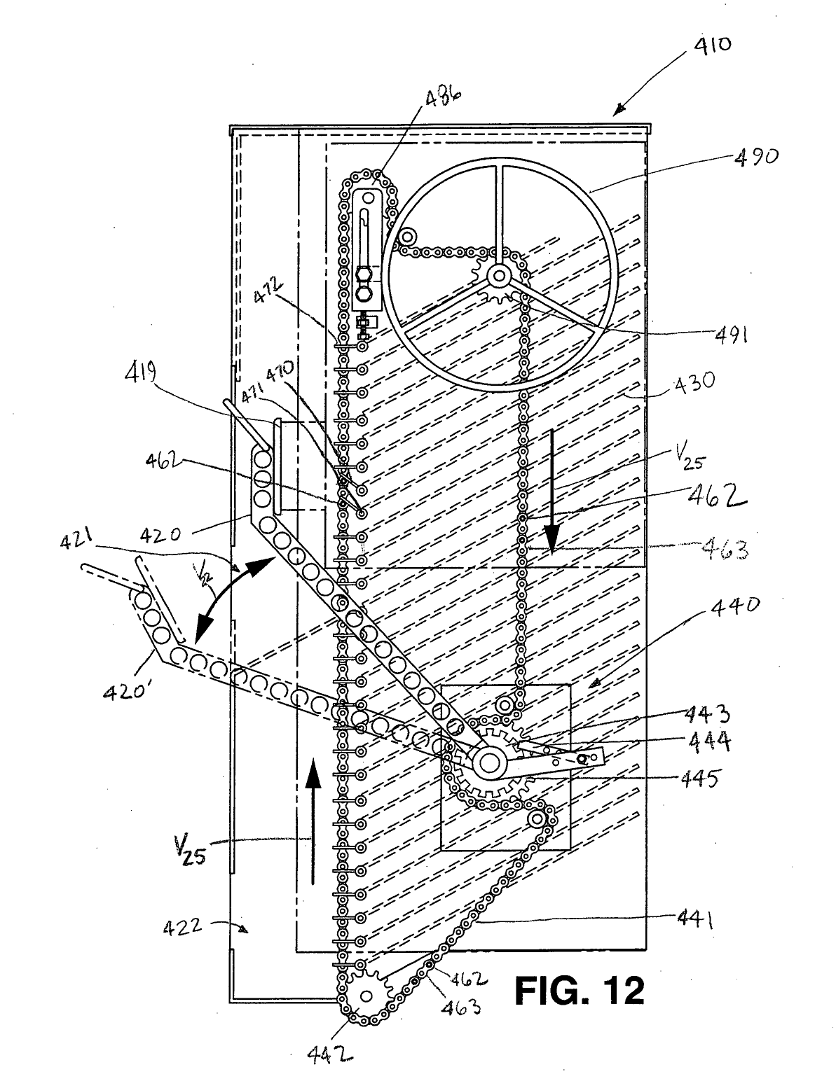

FIG. 12 illustrates a vending machine, generally 410, which employs an activation chain 441 that opens flaps to dispense a periodical in a similar manner as the activation chain shown in FIG. 11, and generally dispenses paper in a similar manner as the vending machine described above. A plurality of trays 430 are provided in which flaps (not shown) hold the periodical on the trays. As with other embodiments, when the flaps are raised the periodicals are dispensed into either an upper dispenser 421 or a lower dispenser 422 depending on the location of the activating mechanism which opens the flaps.

In the embodiment shown, a different drive system 440 is employed. Instead of having a drive chain that drives a gear belt, the single activation chain 441 is employed. The continuous activation chain 441 wraps around a drive sprocket 445, a transfer sprocket 442, a tension sprocket 486, and a hand wheel sprocket 491. The drive sprocket 445 is integral to a ratchet 443. As a handle 420 is pulled in a downward motion V₂₂ to position 420′ the activation chain 441 rotates in a direction V₂₅. The handle 420 pushes the ratchet 443 with a pawl 444 to turn the drive sprocket 445, which advances the chain 441. The activation chain 441 has three sets of activation links 463 that have a pair of activation levers 462 extending therefrom. The sets of activation links 463 are spaced along the chain so that, at any given time, only one pair of activation levers 462, interact with cams 470, which control the flaps (not shown) in front of the trays 430. The cams 470 are integral to shafts 471 of the flaps, so when as activation lever 462 pushes upward on a cam 470, the integral shaft 471 rotates the flaps into an opened position. The pair of activation levers 462 are spaced on the set of activation links 463 so that when the pair of activation levers 462 are interacting with the cams 470, two cams 470 are activated in a row. In this manner, the lead activation lever 462 opens a tray to dispense a periodical, while the second activation lever 462 opens the tray directly below the tray that is dispensing the periodical to discourage the dispensed periodical from being caught by a closing flap. By pulling the handle 420 down to position 420′, the drive sprocket 445 moves the chain 441 so that the activation levers 462 move exactly one position, or distance between two trays 430. Once the handle 420 is let go, it springs back in upward motion V₂₂ resting position against money receptacle 419 to await the next customer.

When it is time to exchange old periodicals for new periodicals, a hand wheel 490 integral to hand wheel sprocket 491 may be turned to advance activity chain 441 upward thereby dispensing all old periodicals still within the vending machine 410. The handle wheel 490 allows the activation chain 441 to advance without having to place money within a money receptacle 419 for each advancement of the chain 441. Further, by using the hand wheel 490, the handle does not have to be pulled for each advancement of the chain 441, either.

To reiterate, it should be understood that the drive system employed in the present subject matter should not be limited to the examples described herein. Automatic drive systems may be employed to drive the vending machine such as electric drive systems or computer-controlled drive system. Other drive systems may be employed as long as these drive systems can operate the flaps to allow the trays to dispense a single periodical at a time.

It will be appreciated by those skilled in the art that various modifications and variations can be made in the present invention without departing from the scope of the invention. It is intended that the present invention include such modifications and variations as come within the scope of the appending claims and their equivalents.

What is claimed:

1. A vending machine for dispensing periodicals one printed periodical at a time, said vending machine comprising:
a housing having a vending side and a back side, said housing forming at least one vending receptacle on said vending side;
a money receptacle integral to said housing;
a plurality of trays disposed within said housing, said trays positioned in parallel alignment slanting from said back side toward said vending side of said housing with each of said trays being able to receive a periodical;
a plurality of flaps interacting with said trays, said flaps preventing dispensation of said periodicals from said trays when said periodicals are placed on said trays; and
a drive system operably connected to said money receptacle, said drive system creating a movement of at least one of said flaps so that a periodical on one of said trays is dispensable into said vending receptacle upon receipt of a proper amount of money by said money receptacle.

2. A vending machine as in claim 1, wherein each of said trays has a corresponding flap from said plurality of said flaps.

3. A vending machine as in claim 2, wherein each of said flaps closes one of said trays to prevent dispensation of said periodical contained on said trays.

4. A vending machine as in claim 3, wherein said flaps are rotatable into an open position to allow dispensation of said periodicals from said trays.

5. A vending machine as in claim 1, wherein each of said flaps includes a cam operably disposed on said flap.

6. A vending machine as in claim 5, wherein each of said flaps includes a shaft integral to said flap, said shaft having said cam carried on an end of said shaft.

7. A vending machine as in claim 6, wherein said drive system includes a rotatable gear belt on which said cams ride as said gear belt rotates.

8. A vending machine as in claim 7, wherein said gear belt defines apertures therein, said apertures properly spaced to allow one of said cams to enter one of said apertures as said gear belt is rotated, whereby said cam rotates said shaft and said flap as said cam enters said aperture.

9. A vending machine as in claim 8, wherein said drive system includes a drive pulley that rotates said gear belt.

10. A vending machine as in claim 9, wherein said drive system includes a transfer sprocket operably connected to said drive pulley by a shaft along an axis of rotation of said transfer sprocket and said drive pulley, and a drive sprocket operably engaging said transfer sprocket by a chain so that, as said drive sprocket is turned, said chain turns said transfer sprocket and thereby said drive pulley.

11. A vending machine as in claim 10, wherein a handle is attached to said drive sprocket to advance the drive sprocket.

12. A vending machine as in claim 11, wherein said handle has a pawl pivotally attached thereto and said drive sprocket has a ratchet wheel secured thereto with said ratchet wheel and said drive sprocket sharing an axis of rotation, whereby said pawl engages said ratchet wheel as said handle is activated.

13. A vending machine as in claim 6, wherein said drive system includes an activation chain, said activation chain having activation levers that are contactable with said cams as said activation chain rotates.

14. A vending machine as in claim 13, wherein said levers are properly spaced to allow one of said levers to contact one of said cams, causing said cam to rotate said flap on which said cam is disposed to allow dispensation of a periodical.

15. A vending machine as in claim 1, wherein said drive system is removable from said vending machine.

16. A vending machine as in claim 1, further comprising a base on which said housing stands having a support arm and a support pipe disposed to said housing.

17. A vending machine as in claim 16, wherein said housing includes a casing enclosing said vending side of said housing and holding said trays within said housing and a back cover forming the back side of said housing for opening and closing said casing.

18. A vending machine as in claim 17, wherein said back cover is attachably affixed to said support pipe and said casing is rotatable about said support pipe so that said trays are accessible for loading of said periodicals.

19. A vending machine as in claim 1, further comprising a viewing window on said vending side of said housing, said viewing window permitting a periodical placed on a top tray of said trays to be viewed through said viewing window.

20. A vending machine as in claim 19, wherein said periodical disposed on said top tray is the last periodical to be dispensed.

21. A vending machine as in claim 20, wherein a top tray flap of said flaps interacts with said top tray to extend said top tray to said viewing window and said top tray flap is rotatable downward to allow dispensation of periodical disposed on said top tray.

22. A vending machine as in claim 1, further comprising an advancing mechanism operably connected to said drive system, said advancing mechanism permitting said drive system to create said movement of at least one of said flaps, while bypassing said money receptacle.

23. A vending machine as in claim 22, wherein said advancing mechanism is a hand wheel.

24. A vending machine for dispensing periodicals one printed periodical at a time, said vending machine comprising:
a housing having a vending side and a back side, said housing forming at least one vending receptacle on said vending side;
a money receptacle integral to said housing;
a plurality of trays disposed within said housing, said trays positioned in parallel alignment slanting from said back side to said vending side of said housing with each of said trays being able to receive one of said periodicals;
a plurality of flaps disposed within said housing, such that at least one said flap extends in front of each of said trays at said vending side of said housing preventing dispensation of said periodicals from said trays when said periodicals are placed on said trays;
cams operably connected to ends of said flaps, each of said cams rotating said flap connected thereto when that cam is activated;
a drive sprocket and transfer sprocket carried within said housing, said drive sprocket and transfer sprocket operably engaged by a chain with said drive sprocket turning said transfer sprocket by said chain, said transfer sprocket connected in parallel to a drive pulley;
a gear belt on which said cams ride operably engaging said drive pulley, said gear belt forming apertures therein in alignment with cams, said apertures spaced to allow one of said cams to enter one of said apertures as said gear belt is rotated by said drive pulley;
a handle operably connected to said money receptacle and engaging said drive sprocket, said handle turning said drive sprocket which turns said transfer sprocket and said drive pulley causing said gear belt to advance when the proper amount of money is received by said money receptacle; and
said gear belt activating one of said cams as said gear belt advances causing said flap attached to said cam to rotate upward thereby allowing said tray to be opened to dispense a periodical disposed thereon.

25. A vending machine for dispensing periodicals one printed periodical at a time, said vending machine comprising:
a housing having a vending side and a back side, said housing forming at least one vending receptacle on said vending side;
a money receptacle integral to said housing;
a plurality of trays disposed within said housing, said trays slantably positionable to dispense a periodical;
a plurality of flaps interacting with said trays; and
a drive system operably connected to said money receptacle, said drive system creating a movement of at least one of said flaps so that a periodical on one of said trays is dispensable into said vending receptacle upon receipt of a proper amount of money by said money receptacle.

26. A vending machine as in claim 25, wherein said flaps prevent dispensation of said periodicals from said trays when said periodicals are placed on said trays.

27. A vending machine as in claim 26, wherein said trays positioned in parallel alignment slanting from said back side toward said vending side of said housing with each of said trays being able to receive said periodical.

28. A vending machine as in claim 27, wherein each of said trays has a corresponding flap from said plurality of said flaps.

29. A vending machine as in claim 28, wherein each of said flaps closes one of said trays to prevent dispensation of said periodical contained on said trays.

30. A vending machine as in claim 29, wherein said flaps are rotatable into an open position to allow dispensation of said periodicals from said trays.

31. A vending machine as in claim 29, wherein said drive system includes an activation chain, said activation chain having activation levers that rotate said flaps into an open position to allow dispensation of said periodicals from said trays.

32. A vending machine as in claim 25, further comprising an advancing mechanism operably connected to said drive system, said advancing mechanism permitting said drive system to create said movement of at least one of said flaps, while bypassing said money receptacle.

33. A vending machine as in claim 32, wherein said advancing mechanism is a hand wheel.

34. A vending machine for dispensing periodicals one printed periodical at a time, said vending machine comprising:
a housing having a vending side and a back side, said housing forming at least one vending receptacle on said vending side;
a money receptacle integral to said housing;
a plurality of trays disposed within said housing, said trays slantably positionable to dispense a periodical;
a plurality of flaps interacting with said trays;
cams operably connected to ends of said flaps, each of said cams rotating said flap connected thereto when that cam is activated;
an activation chain having activation levers interacting with said cams, said activation levers are contactable with said cams as said activation chain rotates;
a drive sprocket rotatably engaging said activation chain;
a handle operably connected to said money receptacle and engaging said drive sprocket, said handle turning said drive sprocket to advance said activation chain; and
at least one of said activation levers activating at least one of said cams as said activation chain advances causing said flap attached to said cam to rotate upward thereby allowing said tray to be opened to dispense a periodical disposed thereon.
